(19) United States
(12) Patent Application Publication
(10) Pub. No.: US 2011/0163235 A1
(43) Pub. Date: Jul. 7, 2011

(54) SCINTIGRAPHIC DEVICE WITH HIGH SPATIAL RESOLUTION

(75) Inventors: Alessandro SOLURI, Rome (IT); Roberto MASSARI, Rome (IT); Mariachiara SCANDELLARI, Nettuno (Rome) (IT); Giulia TRINCI, Rome (IT)

(73) Assignee: C.N.R. CONSIGLIO NAZIONALE DELLE RICERCHE, Rome (IT)

(21) Appl. No.: 12/955,048

(22) Filed: Nov. 29, 2010

(30) Foreign Application Priority Data
Dec. 18, 2009 (IT) RM2009A000666

(51) Int. Cl. G01T 1/20

(52) U.S. Cl. 250/361 R

(57) ABSTRACT

A scintillation device with high resolution includes a detection unit (3) to convert into light radiation an ionising radiation originating from a source under examination and a collimator (2) made of a material with high atomic number 3nd including a plurality of grids (4), the grids (4) co-operating with each other in mutually sliding fashion in a transverse direction to the direction of detection (R) to provide a partial coverage of the detection unit (3) in such a way as to expand and reduce in an adjustable manner a surface area of the detection unit (3) offered to the radiation.

### BACKGROUND OF THE INVENTION

The present invention relates to a scintigraphic device with high spatial resolution.

Traditional scintigraphic devices (called “gamma cameras”) essentially comprise a collimator and a detection unit.

The detection unit transforms an ionising radiation (gamma rays) into an electrical signal, legible by a reading system, e.g. a computer. The electrical signal is amplified and conducted to the computer to recreate the image of the radiation source.

In particular, known detection units comprise a matrix of scintillation crystals, which convert the gamma radiation into light radiation, and optoelectronic device (phototubes, photodiodes and the like) positioned downstream of the crystal matrix to transform the light radiation into the aforesaid electrical signal.

Other known detection units comprise semiconductor elements which directly transform the gamma radiation into the aforementioned electrical signal.

The collimator is instead placed between an object that emits gamma radiation and the detection unit and it has the function of allowing the passage only of the radiation directed substantially perpendicularly to the detection unit shielding all radiation directed in different directions.

In particular, the collimator is defined by a body made of a material with a high atomic number, able to absorb the gamma radiation, and having a matrix of mutually parallel holes that conduct to the detection unit.

The incident gamma radiation is then modulated by means of the collimator which acts by shielding the part of radiation whose angle of incidence deviates by more than a certain angle from a direction perpendicular to the detection unit and that therefore impacts against the lateral walls (baffles) of the collimator holes.

The gamma camera is used in “imaging” systems for diverse applications, such as diagnostic applications (like PET, SPECT and conventional scintigraphies), in Astrophysics and in systems for industrial non-destructive tests.

As stated previously, the collimator has the purpose of selecting the directions of the photons incident on the scintillation structure. In the case of the collimator with parallel holes, only the photons incident perpendicularly to the surface of the camera will be able to reach the detection unit. The collimator therefore geometrically defines the visual field of the camera and contributes to determine, with its specific geometric characteristics, the spatial resolution and the detection efficiency of the system. Normally, in clinical use, modern gamma cameras have the possibility of utilising different types of collimators having specific characteristics, to be adopted according to the energy of the radioisotope used and to obtain the best compromise between spatial resolution and detection efficiency. In the case of collimators with parallel holes, spatial resolution and geometric efficiency can be expressed as a function of the dimensions of the collimator. If “L” is the length of the holes, “d” their width (or diameter) and “z” the distance between source and collimator, the spatial resolution “Rc” of the collimator is given by:

$${R}_{c} = \frac{d ( L + z )}{L}$$

The desirable improvement of the spatial resolution “Rc”, hence the reduction of its value, is achieved by increasing the length “L” of the holes or increasing the number of holes per unit of surface (maintaining an adequate thickness of the separator baffles), thus reducing the width “d”, so that a higher number of forums of lesser width can be housed in the same total area.

In general, although increasing the length “L” determines an improvement in spatial resolution, at the same time it causes a reduction in the total flow of the radiation that reaches the detection unit, and this contributes to lower the overall detection efficiency, making it unsuitable for application in which the emission of radiation is weak. To offset this drawback, it is necessary to extend acquisition times, in order to acquire a sufficient quantity of radiation to assure reliable detection.

The fact remains that, on the contrary, a reduction in the length “L” of the holes of the collimator increases detection efficiency but, disadvantageously, it significantly penalises its resolution, bringing it to values that are not often acceptable in traditional diagnostics.

Therefore, oftentimes the length of the collimator holes and their width are appropriately selected to try to promote an acceptable value of spatial resolution combined with good detection efficiency.

However, such solutions are a compromise set at the time of construction of the device and their performance (resolution, efficiency) cannot be modified in use.

A solution, proposed by the applicant and described in U.S. Pat. No. 6,734,430, consists of aligning the scintillation crystals to the collimator holes. This method enables to achieve good results in terms of overall efficiency, making the areas of the separation resins between the crystals, or the metallic separation structures between them, match the foils of the collimator, whilst spatial resolution depends on the dimensions of the scintillation elements used. Even using more advanced phototubes like the PSPMT (position Sensitive Photo Multiplier Tube), the broadening of the charge produced in individual crystals hampers the localization of the individual scintillation events within the crystal.

In particular, within an individual crystal the possibility of distinguishing separate scintillation events entails a high complexity of the electronics linked to the method of reading the charge collected on all the anodes comprising the phototube.

In view of the above description, it is deduced that use of a fixed collimator with a determined size of the holes implies in fact a resolution that is a set characteristic of the detector which therefore cannot be improved.

The only possibility would reside in replacing the collimator with a more suitable collimator according to the diagnostic test to be performed. However, such a replacement is very inconvenient and it entails a series of technical operations that prevent the immediate use of the equipment. Moreover, this solution does not overcome the problem linked to the low detection efficiency and to the high acquisition times when the length of the collimator increases.

### SUMMARY OF THE INVENTION

In this context, the technical task at the basis of the present invention is to propose a scintigraphic device with high spatial resolution that overcomes the aforementioned drawbacks of the prior art.

In particular, an object of the present invention is to make available a scintigraphic device that has high spatial resolution.

An additional object of the present invention is to make available a scintigraphic device that has high acquisition efficiency.

A further object of the present invention is to propose a scintigraphic device with high spatial resolution that has high operating flexibility, and in particular that allows to adjust resolution to a desired value.

Yet another object of the present invention is to propose a scintigraphic device with high spatial resolution that has high simplicity and ease of use, and in particular that does not require complex interventions to replace parts and/or components for use.

The specified technical task and the objects set out above are substantially achieved by a scintigraphic device with high spatial resolution comprising the technical characteristics exposed in one or more of the appended claims.

### BRIEF DESCRIPTION OF THE DRAWINGS

Further characteristics and advantages of the present invention shall become more readily apparent from the indicative, and therefore not limiting, description of a preferred but not exclusive embodiment of a scintigraphic device with high spatial resolution as illustrated in the accompanying drawings in which:

FIG. 1 is a simplified lateral view of a scintigraphic device according to the present invention;

FIG. 2 is a perspective view of a part of FIG. 1;

FIGS. 3A-3D represent a detail of the part of FIG. 2 in a first embodiment and in accordance with different operating configurations;

FIGS. 4A-4I represent a detail of the part of FIG. 2 in a second embodiment and in accordance with different operating configurations;

FIG. 5 is a perspective view of a component of the part of FIG. 2;

FIG. 6 is a simplified plan view of a portion of the component of FIG. 5.

### DESCRIPTION OF THE PREFERRED EMBODIMENTS

In accordance with the accompanying figures, the reference number 1 designates in its entirety a scintigraphic device according to the present invention.

The scintigraphic device comprises, in its most basic elements, a collimator 2 and a detection unit 3, which are included within a protective external casing (not shown), not permeable to a ionizing radiation (such as gamma radiation).

The description that follows will mainly refer to the collimator 2 of the present invention, whilst the detection unit 3 is substantially known and it will not be described in detail.

By way of example, the detection unit 3 may be of the type comprising:
a matrix of scintillation crystals (not shown), e.g. of the type described in U.S. Pat. No. 6,734,430 in the name of the Applicant;
a photomultiplier associated with the crystal matrix (e.g., a matrix of phototubes, photodiodes, APD (Avalanche Photo Diode) or MPPC (Multi-Pixel Photon Counter)).

The photomultiplier is connected to at least one electronic computing unit whose task is to determined the position of a scintillation event within the crystal matrix.

According to an alternative embodiment, the scintillation crystal matrix can be replaced with a single planar scintillation crystal.

According to a different embodiment, the detection unit 3 can comprise a plurality of semiconductor elements, whose task is directly to convert the incident radiation into an electrical signal readable by the electronic computing unit.

For all the aforementioned embodiments, a collimator 2 in accordance with the description that follows may be employed.

In the remainder of the present description, reference shall in any case be made to the embodiment in which the detection unit 3 comprises a matrix of scintillation crystals.

Each crystal of the aforementioned crystal matrix presents a receiving surface oriented towards a direction of detection “R” (which will be defined in detail below) and able to receive an ionising radiation. In other words, the receiving surface of the individual crystals is oriented towards the collimator 2 to receive the radiation emerging from it, and it is preferably perpendicular to the direction of detection “R”.

In wholly similar fashion, the single planar crystal as well as the plurality of semiconductor elements present the aforementioned receiving surface oriented towards the direction of detection “R”.

The collimator 2 will now be described in detail.

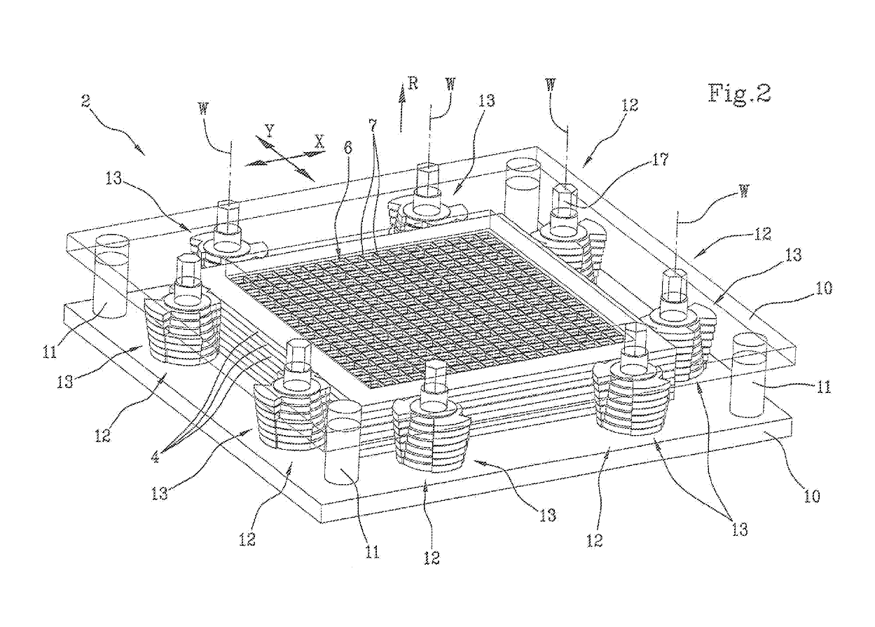

FIG. 2 shows a perspective and partially see-through view of the collimator 2.

The collimator 2 comprises a plurality of shielding elements 4 superposed to define a single collimation body.

The shielding elements 4 are mutually superposed along the direction of detection “R”. In this configuration, the shielding elements 4 are in mutual contact and assume a compacted configuration along the aforementioned direction of detection “R”.

Each shielding element 4 comprises a grid 5 having a matrix of collimation holes 6 separated from each other by separating baffles 7 which are made of a material with high atomic number and high density, to be able to absorb gamma radiation without being traversed thereby. For example, said material may be tungsten, lead or other similar materials.

In accordance with a preferred embodiment, the shielding elements 4 present a prevalent plane of development.

Moreover, the shielding elements 4 are preferably entirely made of the aforementioned material with high atomic number and high density.

The collimation holes 6 are preferably quadrangular and yet more preferably square, and they are positioned according to a distribution that is the same for all shielding elements 4.

Preferably, the shielding elements are mutually identical.

According to the illustrated embodiment, on each shielding element 4 the collimation holes 6 are positioned according to ordered rows and columns, in particular according to a square matrix.

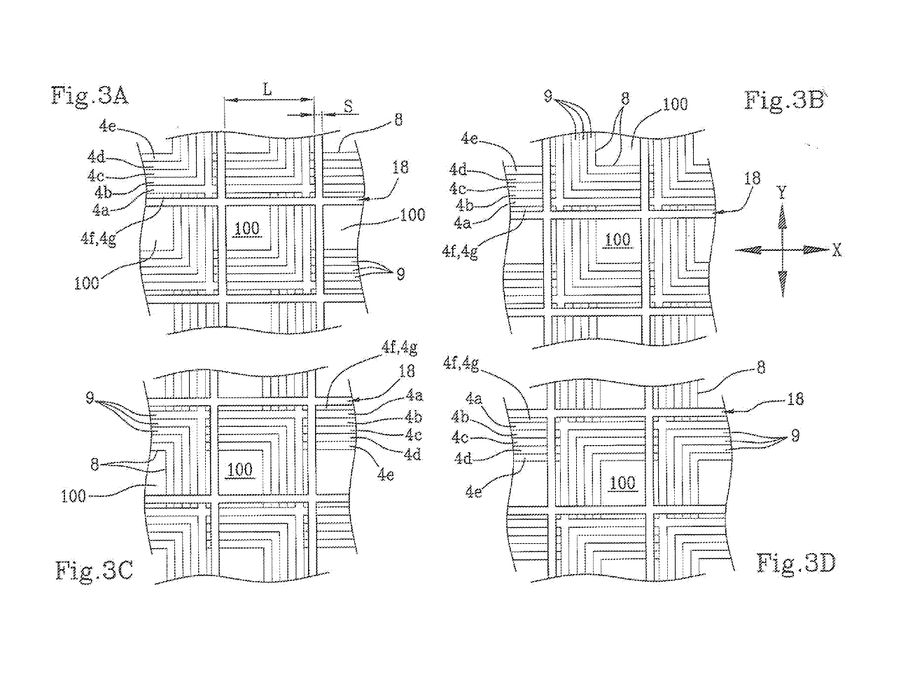

In greater detail, as shown in FIG. 3A, the separating baffles 7 present lateral surfaces 8 which laterally delimit the aforementioned collimation holes 6, and frontal surfaces 9 perpendicular to the lateral surfaces and defining a thickness “s” of the separating baffles 6.

The collimation hole 6 allow the passage of an ionizing radiation directed along the aforesaid direction of detection “R” which is preferably perpendicular to the prevalent plane of lay of the shielding elements 4.

In this circumstance, the lateral surfaces 8 of the separating baffles 7 are parallel to the direction of detection “R” whilst the frontal surfaces 9 are perpendicular to the direction of detection “R”.

Consequently, the aforementioned frontal surfaces 9 define shielding walls able to intercept and absorb part of the ionizing radiation directed towards the detection unit 3.

The collimation holes 6 are then mutually parallel and parallel to the direction of detection “R”.

In a position of alignment between the separating baffles 7 of the different shielding elements 4, the collimation holes 6 are mutually aligned and they co-operate to define respective collimation channels whose length is equal to the length of the collimation body constituted by the superposed shielding elements 4.

In other words, in the aforementioned alignment configuration the collimation holes 6 are perfectly aligned to the individual scintillation crystals.

Advantageously, the shielding elements 4 are movable in sliding fashion relative to each other along the respective prevalent planes of lay.

Preferably, to promote mutual sliding between the shielding elements 4, between two adjacent shielding elements 4 is interposed at least one layer made of an anti-friction material, preferably Teflon, which is preferably applied stable on at least one face of each shielding element 4.

In particular, the shielding elements 4 are movable in sliding fashion relative to each other according to a plurality of configuration of mutual superposition in which they cover different parts of the receiving surface of the detection unit 3, and in particular of each scintillation crystal, to vary the portion of said receiving surface offered to the ionizing radiation. Each configuration of mutual superposition of the shielding elements 4 corresponds to the exposure to the ionizing radiation of specific sub-areas 100 of the receiving surface, and said exposed areas are different from the sub-areas 100 exposed in the other superposition configurations. Consequently, a specific sub-area 100 of the receiving surface of the detection unit 3 is exposed only in a specific configuration of superposition of the shielding elements 4, defining a bi-univocal correlation between the sub-area 100 under consideration and the displacements to be imparted to the different shielding elements 4 necessary to expose said sub-area 100 to the radiation.

In other words, the shielding elements 4 can be offset with respect to each other in such a way that the separating baffles 7 (and in particular the frontal surfaces 9) of a first shielding element 4 are offset relative to the separating baffles 7 of a second shielding element 4 in such a way as to cover at least partially the collimation holes 7 of the aforesaid second shielding element 4.

This allows to expand and reduce in an adjustable manner the surface of the scintillation crystals actually offered to the ionising radiation.

Advantageously, the result is that, varying the measure and the direction of the mutual offset of the shielding elements 4 it is possible to define the position and the extension of the surface portion of each scintillation crystal offered to the ionising radiation or, more in general, to expose to the ionizing radiation, from time to time, different areas of the receiving surface of the detection unit 3.

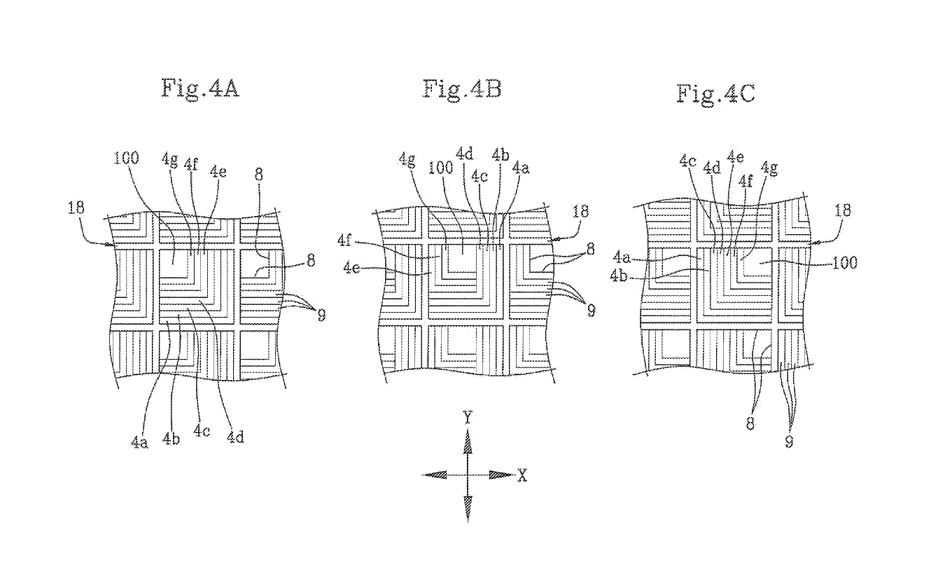

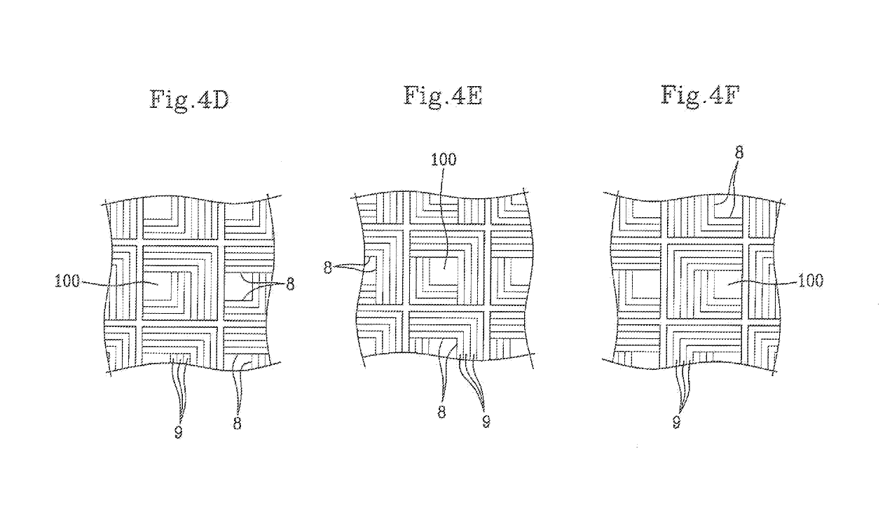

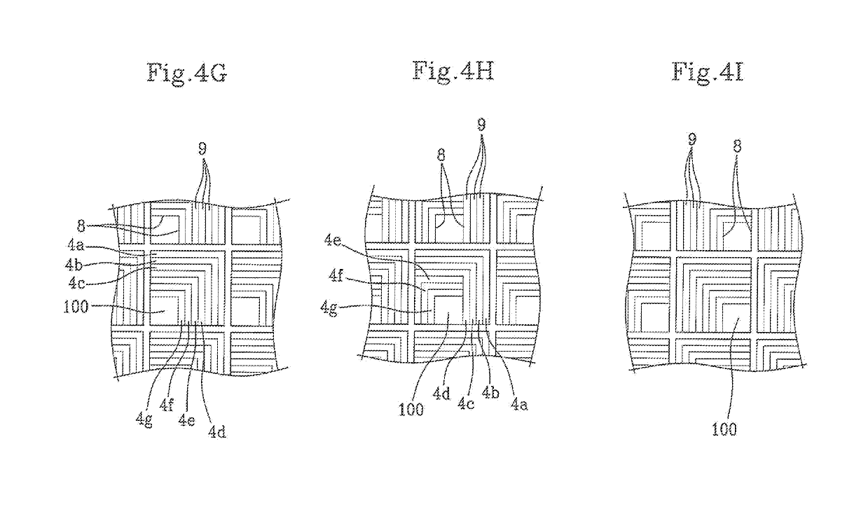

In this way, the receiving surface of each scintillation crystal (or more generally the receiving surface of the detection unit 3) can be ideally subdivided into sub-areas 100 (FIGS. 3A-3D and 4A-4I) each of which can be selectively offered to the ionising radiation whilst the remaining part of the receiving surface is shielded and is not impacted by said radiation.

Therefore, the shielding elements 4 have the dual function of reducing the surface of the scintillation crystals offered to the ionising radiation and, at the same time, of adjustably expanding and reducing the quantity of ionising radiation addressed towards each scintillation crystal.

In other words, the superposition effect of the shielding elements 4 induces a narrowing of the actual section of the collimation channels and, hence, a reduction in the section of the beam of ionizing radiation that flows through the collimator 2. The adjustment of the positioning of the individual shielding elements 4 thus enables to address a predetermined part of the ionizing radiation towards a predetermined part of the surface of the detection unit 3 (and in particular of the receiving surface of each scintillation crystal or of the individual planar crystal or, otherwise, of the semiconductor elements).

If a crystal matrix is used, it is therefore possible to complete a plurality of readings, each achieved by detecting the scintillation events in a specific configuration of the shielding elements and then compose the succession of readings (by the computing unit) to obtain a high resolution image of the source of the ionising radiation.

More in general, the detection unit 3 measures the quantity of ionizing radiation incident on the part (sub-area 100) of the receiving surface freed from time to time by the shielding elements, obtaining a succession of readings, each corresponding to a predetermined sub-area 100 of the receiving surface. The composition of the different readings on the basis of a “collage” provided by the different sub-areas provides a high resolution image of the shape of the radiation source.

For example, if the surface of a sub-area 100 constitutes a sub-multiple of the receiving surface of each crystal, the scintillation events that involve the crystal could be subdivided and recognized on the basis of the sub-area 100 associated to them, thus increasing the precision of the detection and hence the resolution.

Preferably, the pack of shielding elements 4 is positioned between two containment plates 10, each provided a central opening to allow the ionizing radiation to traverse the collimation holes 7.

The containment plates 10 are positioned perpendicularly to the direction of detection “R”.

The containment plates 10 are kept tight against each other by means of pins 11 (FIG. 2).

FIGS. 2, 5 and 6 show the actuating means 12 used to actuate the shielding elements 4.

Said means 12 comprise cam means positioned in sliding contact relationship with the shielding elements 4 to translate a rotation motion of at least one cam 13 into mutual sliding motion between at least two shielding elements 4.

Preferably, the actuating means 12 comprise a plurality of cams 13 for actuating the shielding elements 4.

Advantageously, the actuating means 12 are active on the shielding elements 4 to actuate them according to two direction of actuation “X”, “Y” preferably perpendicular to each other and preferably perpendicular to the direction of detection “R”.

The two directions of actuation “X”, “Y” are preferably parallel to the lateral surfaces 8, 9 of the separating baffles 7.

For the actuation in each of the aforementioned directions of actuation “X”, “Y”, at least one cam 13 is used, preferably two cams positioned at opposite sides of the pack of shielding elements 4 and yet more preferably four cams, two for each of the two opposite sides of the pack of shielding elements 4 (hence, eight cams 13 considering both directions of actuation “X”, “Y”).

The purpose of providing two cams 13 for each side of the pack of shielding elements 4 is to balance the thrust on the shielding elements 4 achieving a thrust on two points.

Additionally, the use of cams 13 on the two opposite sides allows a correct action of bidirectional actuation of the shielding elements 4, the cams 13 being engaged in single relation of sliding bearing relationship with outer lateral surface of the sliding elements 4.

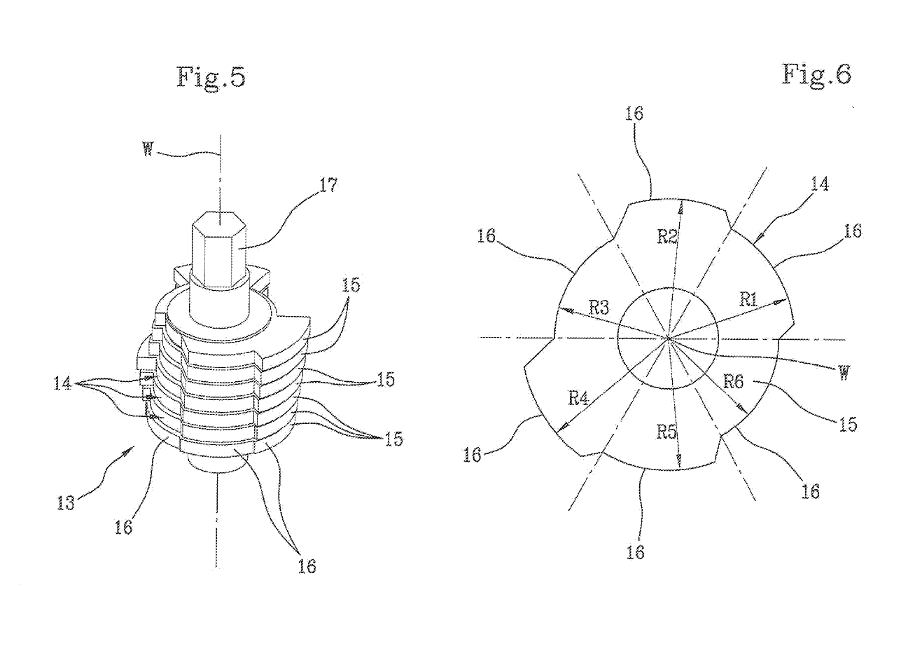

Advantageously, each cam 13 (FIG. 5) presents a plurality of guiding profiles 14 positioned in succession along the axis of rotation “W” of the cam 13. Each guiding profile 14 develops on a closed path and its placed in sliding contact relationship with a respective shielding element 4 in such a way that a rotation of the cam 13 around its own axis of rotation “W” determines different displacements of the shielding elements 4.

The guiding profiles 14 are preferably different from each other and in any case such as to achieve different displacements of the shielding elements 4 at any angular position of the cam 13.

The guiding profiles 14 are preferably defined by a peripheral lateral surface of appropriately shaped disks 15, integral with each other and able to rotate around the aforementioned axis of rotation “W” in such a way that the set of the superposed disks 15 defines the outer profile of the cam 13 (FIG. 5).

Advantageously, moreover, as shown in FIG. 6, each of guiding profiles (14) comprises a succession of arched segments 16 having different respective outer radii 4 to achieve, for each shielding element 4, a different positioning according to the angular positioning of the cam 13 around the related axis of rotation “W”.

Preferably, the consecutive arched segments 16 of each guiding profile are mutually joined to obtain a gradual engagement with the respective shielding element 4.

The cams 13 have axis of rotation “W” parallel to each other and preferably perpendicular to the containment plates 10, hence parallel to the direction of detection “R”.

The cams 13 are actuated by respective electric motors, preferably of the direct current brushless type, not shown in the accompanying figures for simplicity of exposure.

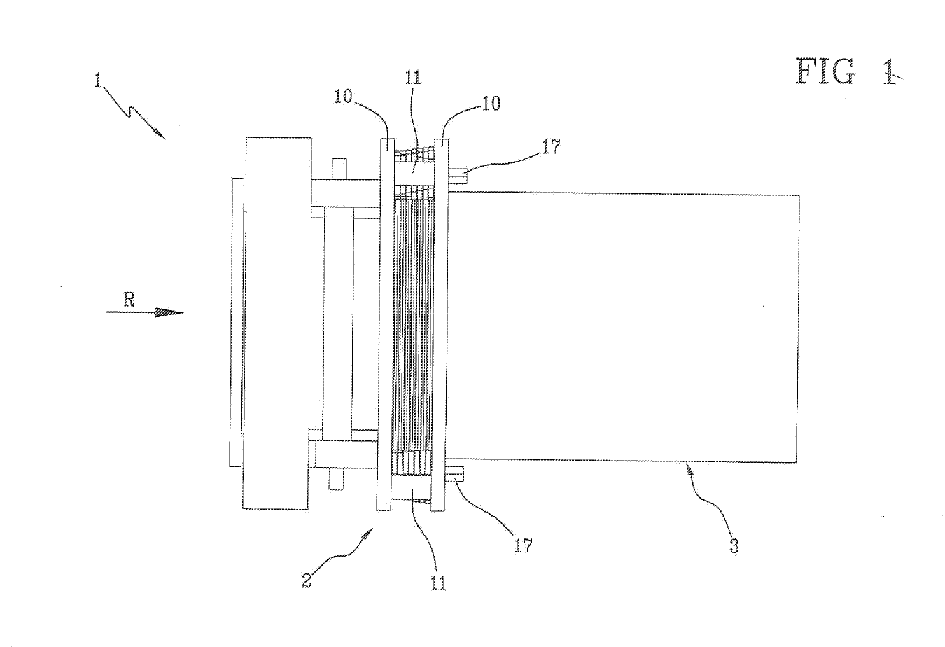

Each electric motor is coupled to a rotation shaft 17 of a respective cam 13, whose shaft 17 is preferably projecting externally to one of the two containment plates 10 (FIGS. 1 and 2).

Preferably, moreover, the collimation upstream of the aforementioned collimator 2 (relative to a direction of flow of the radiation beam along the direction of detection “R”) is achieved with an additional collimation block 18, preferably fixed, illustrated in FIG. 1.

The aforesaid additional collimation block 18 presents a plurality of parallel collimation channels (not shown in detail) positioned according to a fixed mutual orientation and hence defining a fixed collimation grid, relative to which the aforesaid shielding elements 4 are moved.

The aforesaid additional collimation block 18 is positioned adjacently to the aforesaid collimator 2, at the opposite side relative to the detection unit 3, hence more proximate to the source of the radiation to be detected.

According to a first embodiment, the aforesaid additional collimation block 18 is a single block having fixed configuration.

According to an embodiment, the aforesaid additional collimation block 18 is defined by two or more segments, mutually aligned along the direction of detection “R” and movable to approach and distance each other along the direction of detection “R” to obtain a collimation block with variable length.

Preferably, said additional collimation block 18 with variable length is of the type described in patent application in the WO2005116689 Applicant's name, and it can easily be implemented in the device 1 according to the present invention, in particular by installation upstream of the collimator 2 (relative to a direction of flow of the beam of ionising radiation).

### Embodiment

A preferred embodiment of the scintigraphic device according to the present invention is described below, with particular reference to the geometry and to the measurements of the device.

According to the embodiment in question, a matrix of 18×18 CsI (Tl) scintillation crystals is used, in which each crystal has dimensions of 2.05×2.05×5 mm³ (2.05×2.05 are the dimensions of the aforementioned receiving surface of the individual crystal, i.e. the surface oriented towards the collimator 2 and towards the ionising radiation).

The scintillation crystals are coated with a layer of 0.1 millimetres of epoxy resins on the four lateral faces and with a layer of about 1 mm of epoxy resin on the receiving surface. Said coated crystals are integrated in a metallic structure made of tungsten having separating baffles with thickness of 0.2 mm.

With reference to the collimator 2, seven shielding elements 4 (or grids) are provided, mutually superposed and packed by means of the aforesaid containment plates 10.

Each grid 4 has square side dimension of 52.3 millimetres and thickness 1 millimetre and it has a matrix of 18×18 collimation holes 6. Each collimation hole 6 it has square section of width “L” (side) each to 2.25 millimetres whilst the separating baffles have thickness “s” of 0.2 millimetres.

Preferably, a frame is provided with length of 4 millimetres external to the collimation holes 6, i.e. on the perimeter of the grid 4.

The actuation of the eight cams 13 is achieved by using 8 DC Brushless Micro motors with nominal values of maximum velocity of 12,000 rpm and maximum torque of 3.2 mNm.

Recapitulating, therefore, the main data that will be used hereafter:
the width of the collimation holes of the collimator 2 is 2.25 mm;
the thickness of the separating baffles 7 of the collimator is 0.2 millimetres;
the number of grids is 7.

Advantageously, it was seen that use of a collimator 2 having the aforesaid geometric characteristics allows to “subdivide” the working cross section of each collimation channel into four parts (2×2, so-called 4× super-resolution) and into nine parts (3×3, 9× so-called super-resolution).

### Super-Resolution 4×

It is possible to select a sub-area 100 equal to one fourth of the receiving surface of each crystal, and in particular the sub-area 100 at the top left in FIG. 3A, by means of an actuation method that requires predetermined values of displacement of the individual grids 4, in accordance with table 1.

TABLE 1

| | |
|---|---|
| Grid 1 | 0.325 mm upwards, 0.325 mm to the left |
| Grid 2 | 0.525 mm upwards, 0.325 mm to the left |
| Grid 3 | 0.725 mm upwards, 0.325 mm to the left |
| Grid 4 | 0.925 mm upwards, 0.325 mm to the left |
| Grid 5 | 1.125 mm upwards, 0.325 mm to the left |
| Grid 6 | 0.125 mm upwards, 0.325 mm to the left |
| Grid 7 | 0.125 mm upwards, 0.325 mm to the left |

The term grid 1 can preferably mean the grid positioned most proximate to the source of the radiation.

With reference to the accompanying figures, positive displacement values mean an upward (or rightward) displacement whilst negative displacement values mean a downward (or leftward) displacement.

It should be noted that the displacement of the grid 1 is obtained by offsetting the grid by 0.2 millimetres (equal to the thickness of the separating baffle of the grid) upwards and rightward with respect to the grids 6 and 7, which are superposed.

Similarly for grid 2 with respect to grid 1, and so on.

A configuration of the type shown in FIG. 3A is obtained (illustrated by enlarging a part of the entire grid).

Obtaining the other three sub-areas 100 (FIGS. 3B, 3C, 3D) is possible by:
rightwards instead of leftwards displacement by the same quantity (FIG. 3B);
downwards instead of upwards displacement by the same quantity (FIG. 3C);
rightwards instead of leftwards displacement and downwards instead of upwards displacement by the same quantity (FIG. 3D);
   In FIGS. 3A-3D, the first grid is indicated by the reference 4a, the second one by 4b and so on to the seventh grid, indicated by 4g.

Moreover, the grid shown in bold lines is defined by the collimation block 18, which is fixed and is not affected by the displacements governed by the cams 13.

Since the area of each collimation hole 6 (hence of the receiving surface of each crystal, if a scintillation crystal matrix is used) is subdivided into four sub-areas 100 (2×2), the total receiving area of the detection unit 3 is subdivided into 36×36 sub-areas. With an appropriate data processing software implemented in the computing unit, it is possible to compose a resulting image of the source of the ionising radiation, with double spatial resolution with respect to the case with a collimator with fixed grid.

### Super-Resolution 9×

It is possible to select a sub-area 100 equal to 1/9 of the receiving surface of each crystal by means of an actuation method that requires predetermined values of displacement of the individual grids 4, in accordance with table 2.

The displacements are indicated in the horizontal (axis X) and vertical (axis Y), positive upwards and rightwards, and they are expressed in millimetres.

TABLE 2

| | Displacements of the grids in mm | | | | | | | | | | | | | |
|---|---|---|---|---|---|---|---|---|---|---|---|---|---|---|
| | Grid 1 | | Grid 2 | | Grid 3 | | Grid 4 | | Grid 5 | | Grid 6 | | Grid 7 | |
| | X | Y | X | Y | X | Y | X | Y | X | Y | X | Y | X | Y |
| A | −0.2 | +0.2 | −0.4 | +0.4 | −0.6 | +0.6 | −0.8 | +0.8 | −1.0 | +1.0 | −1.2 | +1.2 | −1.4 | +1.4 |
| B | −0.2 | +0.2 | −0.4 | +0.4 | −0.6 | +0.6 | −0.8 | +0.8 | +0.2 | +1.0 | +0.4 | +1.2 | +0.6 | +1.4 |
| C | +0.2 | +0.2 | +0.4 | +0.4 | +0.6 | +0.6 | +0.8 | +0.8 | +1.0 | +1.0 | +1.2 | +1.2 | +1.4 | +1.4 |
| D | −0.2 | −0.2 | −0.4 | −0.4 | −0.6 | −0.6 | −0.8 | −0.8 | −1.0 | +0.2 | −1.2 | +0.4 | −1.4 | +0.6 |
| E | −0.2 | −0.2 | −0.4 | −0.4 | −0.6 | −0.6 | −0.8 | −0.8 | +0.2 | +0.2 | +0.4 | +0.4 | +0.6 | +0.6 |
| f | +0.2 | −0.2 | +0.4 | −0.4 | +0.6 | −0.6 | +0.8 | −0.8 | +1.0 | +0.2 | +1.2 | +0.4 | +1.4 | +0.6 |
| G | −0.2 | −0.2 | −0.4 | −0.4 | −0.6 | −0.6 | −0.8 | −0.8 | −1.0 | −1.0 | −1.2 | −1.2 | −1.4 | −1.4 |
| H | −0.2 | −0.2 | −0.4 | −0.4 | −0.6 | −0.6 | −0.8 | −0.8 | +0.2 | −1.0 | +0.4 | −1.2 | −0.6 | −1.4 |
| I | +0.2 | −0.2 | +0.4 | −0.4 | +0.6 | −0.6 | +0.8 | −0.8 | +1.0 | −1.0 | +1.2 | −1.2 | +1.4 | −1.4 |

Table 2 contains, for each row, the displacements to be attributed to each 4a-4g grid to obtain the selection of a sub-area 100 equal to 1/9 of the receiving surface of each scintillation crystal.

In particular, the letters A-I indicate respectively the sub-area 100 considered (A means the top left area represented in FIG. 4A, B means the top centre area represented in FIG. 4B and so on).

Preferably, for reasons linked to simplicity of construction, more specifically to avoid sudden radial variations in the cams 13 from an arched segment 16 to another, it is preferable to adopt a different order of actuation of the grids, as shown in table 3 (the displacements are in millimetres and positive if considered upwards or rightwards).

TABLE 3

| | | | Downward | Upwards | | Downward |
|---|---|---|---|---|---|---|
| | | Upwards and | and | and | | and |
| | Base | Rightward | Leftward | Rightward | Centre | Leftward |
| | Config. | 4X | 4X | 9X | 9X | 9X |
| Grid 1 | 0 | +0.125 | −1.125 | 0.200 | −0.800 | −1.400 |
| Grid 2 | 0 | +0.525 | −0.525 | 0.800 | 0.200 | −0.600 |
| Grid 3 | 0 | +1.125 | −0.125 | 1.400 | 0.400 | −0.200 |
| Grid 4 | 0 | +0.925 | −0.125 | 1.200 | 0.600 | −0.400 |
| Grid 5 | 0 | +0.725 | −0.325 | 1.000 | −0.200 | −0.800 |
| Grid 6 | 0 | +0.325 | −0.725 | 0.600 | −0.400 | −1.200 |
| Grid 7 | 0 | +0.125 | −0.925 | 0.400 | −0.600 | −1.000 |

Table 3 indicates, for example, that in 4× super resolution the grid 1 is actuated with a displacement of +0.125 (hence upwards or rightwards) to select a sub-area 100 positioned above or to the right.

Table 3 also indicates, for example, that in 9× super resolution the grid 1 is actuated with a displacement:
of +0.200 millimetres (hence upwards or rightwards) to select a sub-area positioned above or to the right;
of −0.800 millimetres (hence downwards and leftwards) to select the central sub-area 100 (FIG. 4E);
of −1.400 millimetres (hence downwards or leftwards) to select a sub-area 100 positioned below or to the left;

To achieve the aforesaid movements, the cams 13 present guiding profiles 14 whose arched segments have the diameters specified in table 4.

TABLE 4

| | R1 | R2 | R3 | R4 | R5 | R6 |
|---|---|---|---|---|---|---|
| Profile 1 | 5.000 | 5.125 | 4.875 | 5.200 | 4.200 | 3.600 |
| Profile 2 | 5.000 | 5.525 | 4.475 | 5.800 | 5.200 | 4.400 |
| Profile 3 | 5.000 | 6.125 | 4.875 | 6.400 | 5.400 | 4.800 |
| Profile 4 | 5.000 | 5.925 | 4.875 | 6.200 | 5.600 | 4.600 |
| Profile 5 | 5.000 | 5.725 | 4.675 | 6.000 | 4.800 | 4.200 |
| Profile 6 | 5.000 | 5.325 | 4.275 | 5.600 | 4.600 | 3.800 |
| Profile 7 | 5.000 | 5.125 | 4.075 | 5.400 | 4.400 | 4.000 |

In table 4, the radii R1-R7 are expressed in millimetres (and refer to the arched segments shown in FIG. 6) whilst the profiles 1-7 refer respectively to the guiding profiles used to actuate respectively the grids 1-7.

Preferably, the arched segments extend substantially for an angle of 60 degrees around the axis of rotation “W” of the cam 13.

Since the area of each collimation hole 6 (hence of the receiving surface of each crystal, if a scintillation crystal matrix is used) is subdivided into nine sub-areas 100 (3×3), the total receiving area of the detection unit 3 is subdivided into 54×54 sub-areas. With an appropriate data processing software implemented in the computing unit, it is possible to compose a resulting image of the source of the ionising radiation, with double spatial resolution with respect to the case with a collimator with fixed grid.

The present invention achieves the proposed objects, overcoming the drawbacks noted in the prior art.

The use of the sliding grids enables to select, within a single device, a sub-area of a crystal in order to be able to identify from which sub-area of the crystal a predetermined scintillation event is coming.

Consequently, it is possible to improve the spatial resolution of the detection using an extremely flexible device, which requires no replacement of parts or components to adapt it to the different requirements.

Additionally, if a high resolution is not necessary, it is sufficient to maintain the grids in the basic position (i.e. with the respective collimation holes mutually aligned) and thereby benefit from a high detection efficiency.

Moreover, the use (in addition to the collimator with sliding grids) of an additional front collimator enables further to improve resolution, which would be improved even more if said front collimator is of the type with variable length.

1-18. (canceled)

19. High resolution scintillation device, comprising:
a collimator made of a material with high atomic number and presenting a plurality of collimation holes extending substantially parallel relative to each other according to a direction of detection, said collimator being able to allot the passage of ionizing radiation directed substantially parallel to the direction of detection;
a detection unit co-operating with said collimator to convert into light radiation an ionising radiation originating from a source under examination and traversing said collimator; characterised in that said collimator comprises a plurality of shielding elements, co-operating with each other in a mutually sliding manner in transverse direction to said direction of detection to achieve a partial coverage of said detection unit in such a way as to expand and reduce in an adjustable manner a surface area of the detection unit offered to said radiation.

20. Device as claimed in claim 19, wherein each of said shielding elements presents a same distribution and dimension of the collimation holes.

21. Device as claimed in claim 19, wherein said shielding elements are mutually identical.

22. Device as claimed in claim 19, wherein each of said shielding elements comprises a grid having a matrix of collimation holes mutually separated by separating baffles made of a material with high atomic number, and wherein said separating baffles present respective shielding walls oriented towards said direction of detection to intercept and absorb part of the ionising radiation directed parallel to said direction of detection.

23. Device as claimed in claim 22, wherein said collimation holes have quadrangular, preferably square section, and are positioned on said grid according to ordered rows and columns.

24. Device as claimed in claim 22, wherein said separating baffles present lateral surfaces parallel to said direction of detection and laterally delimiting said collimation holes, and frontal surfaces perpendicular to said lateral surfaces and defining a thickness of said separating baffles, said frontal surfaces defining said shielding walls.

25. Device as claimed in claim 19, comprising actuating means active on said shielding elements to actuate them according to a plurality of different operative positions corresponding to different configurations of mutual superposition of the shielding elements, each mutual superposition configuration of the shielding elements corresponding to the exposure to the ionising radiation of specific sub-areas of said receiving surface, different from the sub-areas exposed in the other superposition configurations.

26. Device as claimed in claim 25, wherein said actuating means are active on said shielding elements to actuate them according to two directions of actuation perpendicular to each other and preferably perpendicular to said direction of detection.

27. Device as claimed in claim 25, wherein said actuating means comprise cam means positioned in sliding contact relationship with said shielding elements to translate a rotation motion of at least one cam into mutual sliding motion between at least two of said shielding elements, preferably a simultaneous motion of a plurality of said shielding elements.

28. Device as claimed in claim 27, wherein said cam means comprise at least one cam having a plurality of guide profiles arranged in succession along an axis of rotation of said cam, and wherein each of said guide profiles is positioned in sliding contact relationship with a respective one of said shielding elements in such a way that a rotation of said cam around the respective axis of rotation determines different displacements of said shielding elements.

29. Device as claimed in claim 28, wherein each of said guide profiles comprises a succession of arched segments having respective outer radii of different value to achieve, for each shielding element, a different positioning according to the angular positioning of the cam around the related axis of rotation.

30. Device as claimed in claim 27, wherein said actuating means are active on said shielding elements to actuate them according to two directions of actuation (X, Y) perpendicular to each other and preferably perpendicular to said direction of detection, and wherein said cam means comprise at least two cams to actuate said shielding elements along said two directions of actuation.

31. Device as claimed in claim 30, wherein said cam means comprise, for each direction of actuation, at least two cams positioned at opposite parts of said shielding elements to promote a bi-directional actuation of said shielding elements.

32. Device as claimed in claim 19, wherein said shielding elements are mutually superposed and in which said device comprises at least one layer made of anti-friction material interposed between the two successive shielding elements to promote the mutual sliding of said shielding elements, preferably said layer made of anti-friction material being stably applied on at least one of said shielding elements.

33. Device as claimed in claim 19, further comprising at least one collimation block positioned adjacent to said collimator at opposite side relative to the detection device and co-operating with said collimator to define a shielding grid that is permanently aligned with said detection unit.

34. Device as claimed in claim 19, wherein said detection unit comprises:
a matrix of scintillation crystals each having a receiving surface oriented towards said direction of detection, wherein said shielding elements are slidably movable according to a plurality of operative positions in which they cover different parts of the receiving surface of each crystal to vary the portion of the receiving surface of each crystal offered to the ionizing radiation; and
an optoelectronic device, operatively associated to the crystal matrix to convert a light radiation emitted by said crystals into at least one electrical signal.

35. Device as claimed in claim 19, wherein said detection unit comprises:
a single flat scintillation crystal having said receiving surface oriented towards the direction of detection, wherein said shielding elements are slidably movable according to a plurality of operative positions in which they cover different parts of the receiving surface of each flat crystal to vary the portion of said receiving surface offered to the ionizing radiation; and
an optoelectronic device operatively associated to the crystal matrix to convert a light radiation emitted by said crystals into at least one electrical signal.

36. Device as claimed in claim 19, wherein said detection unit comprises a plurality of semiconductor elements to convert at least a part of an ionizing radiation into at least one electrical signal, wherein each semiconductor element presents a receiving surface oriented towards said direction of detection and wherein said shielding elements are slidably movable according to a plurality of operative positions in which they cover different parts of the receiving surface of each semiconductor element to vary the portion of said receiving surface offered to the ionizing radiation.
